(19) United States
(12) Patent Application Publication
(10) Pub. No.: US 2015/0003441 A1
(43) Pub. Date: Jan. 1, 2015

(54) METHOD AND APPARATUS FOR SYNCHRONIZATION BETWEEN NODES IN WIRELESS NETWORK

(71) Applicant: ELECTRONICS AND TELECOMMUNICATIONS RESEARCH I NSTITUTE, Daejeon (KR)

(72) Inventors: Jihyung KIM, Daejeon (KR); Hyun-jae KIM, Incheon (KR); Kwang Jae LIM, Daejeon (KR)

(73) Assignee: ELECTRONICS AND TELECOMMUNICATIONS RESEARCH INSTITUTE, Daejeon (KR)

(21) Appl. No.: 14/260,579

(22) Filed: Apr. 24, 2014

(30) Foreign Application Priority Data
Jul. 1, 2013 (KR) 10-2013-0076694

(51) Int. Cl. H04L 27/26; H04W 56/00

(52) U.S. Cl. CPC H04L 27/2656; H04W 56/001
USPC 370/350

(57) ABSTRACT

In accordance with an exemplary embodiment, a method of a first node synchronizing reception points of time in a wireless network is provided. The first node receives signals from a plurality of second nodes adjacent to a first node at a first point of time. The first node excludes at least one of the plurality of second nodes if a difference between points of time at which the signals are received from the plurality of second nodes is greater than a length of a cyclic prefix (CP) of one symbol. The first node sets an initial value of a point of time at which FFT is started using a point of time at which the signal transmitted by at least any one of remaining second nodes not excluded in the excluding step is received.

### CROSS-REFERENCE TO RELATED APPLICATION

This application claims priority to and the benefit of Korean Patent Application No. 10-2013-0076694 filed in the Korean Intellectual Property Office on Jul. 1, 2013, the entire contents of which are incorporated herein by reference.

### BACKGROUND OF THE INVENTION

(a) Field of the Invention

The present invention relates to a method and apparatus for synchronization between nodes in a wireless network.

(b) Description of the Related Art

In a wireless network, a synchronization method for performing synchronization on a node that has transmitted a beacon using time information about the node that has transmitted the beacon is chiefly used. A case where nodes are placed within an allowable distance range, that is, a case where the distance between nodes is similar, or a case where propagation delay is not great, is a precondition for this synchronization method. Accordingly, if the distance between nodes is different, a synchronization method in which propagation delay according to the distance and a difference between clock values of the nodes in the case of distributed topology are taken into consideration is necessary. Furthermore, a synchronization method is necessary if an orthogonal frequency division multiplexing (OFDM) method is used. This synchronization method is described in Korean Patent Laid-Open Publication Nos. 10-2012-0071954 and 10-2012-0126448.

Meanwhile, in the synchronization methods described in Korean Patent Laid-Open Publication Nos. 10-2012-0071954 and 10-2012-0126448, round trip delay (RTD) between nodes is estimated through a ranging process, and all nodes set points of time at which frames are started identically early in a synchronization process. Accordingly, points of time at which a specific node transmits/receives frames are determined by estimating points of time at which adjacent nodes transmit/receive frames. That is, the existing synchronization method requires a ranging process, an RTD estimation process, and a frame start time point setting process.

### SUMMARY OF THE INVENTION

The present invention has been made in an effort to provide a simple synchronization method without a ranging process, an RTD estimation process, and a frame start time point setting process.

An exemplary embodiment of the present invention provides a method of a first node synchronizing reception times in a wireless network. The synchronization method includes the steps of: receiving signals from a plurality of second nodes adjacent to a first node at a first point of time; excluding at least one of the plurality of second nodes when a difference between points of time at which the signals are received from the plurality of second nodes is greater than the length of a cyclic prefix (CP) of one symbol; setting an initial value of a point of time at which fast Fourier transform (FFT) is started using a point of time at which the signal transmitted by at least any one of remaining second nodes not excluded in the excluding step is received; requesting the second node, excluded in the excluding step, to change a point of time at which a signal is transmitted; and receiving signals from the excluded second node requested to change a point of time at which a signal is transmitted and the remaining second nodes not excluded at a second point of time and updating the point of time at which FFT is started.

The excluding step includes: a first step of excluding any one of a node that has transmitted the last arrived signal, a node that has transmitted a signal having the weakest reception power, and a node that has transmitted a signal having the greatest difference between a point of time at which the signal transmitted by the node is received and an average value of points of time at which the received signals are received, from among the second nodes that have transmitted the received signals, when a first condition defining whether a difference between a point of time at which an earliest arrived signal, from among the received signals, is received and a point of time at which the last arrived signal is received is smaller than or equal to the length of the CP is not satisfied; and a second step of repeatedly performing the first step on signals received from remaining second nodes not excluded in the first step until the first condition is satisfied.

The step of setting an initial value of a point of time at which FFT is started includes the steps of: setting any one of a value obtained by adding the length of the CP to a point of time at which a earliest arrived signal, from among signals transmitted by remaining second nodes, not excluded and satisfying the first condition, is received, a value obtained by adding the length of the CP to a point of time at which a signal having strongest reception power, from among the signals transmitted by the remaining second nodes, not excluded and satisfying the first condition, is received, and a value obtained by adding the length of the CP to an average value of points of time at which the signals transmitted by the remaining second nodes, not excluded and satisfying the first condition, are received as the initial value of the point of time at which FFT is started; and setting an initial value of a point of time at which a signal is transmitted identically with the initial value of the point of time at which FFT is started.

The step of requesting the second node, excluded in the excluding step, to change the point of time at which the signal is transmitted, includes sending a message instructing the excluded second node to delay a point of time at which a signal is transmitted when the point of time at which the signal transmitted by the excluded second node is received is earlier than a point of time at which a signal transmitted by any one of the remaining second nodes, not excluded and satisfying the first condition, is received to the excluded second node, and sending a message instructing the excluded second node to advance a point of time at which a signal is transmitted when the point of time at which the signal transmitted by the excluded second node is received is later than a point of time at which a signal transmitted by any one of the remaining second nodes, not excluded and satisfying the first condition, is received to the excluded second node.

A switching gap between frames transmitted or received by the first node includes a first guard interval, a second guard interval, and a switching interval. Here, the first guard interval is an interval in which a point of time at which a signal is transmitted or a point of time at which a signal is received is delayed, the second guard interval is an interval in which a point of time at which a signal is transmitted or a point of time at which a signal is received is advanced, and the switching interval is placed between the first and second guard intervals and is an interval in which transmission is switched into reception or from reception to transmission.

The step of updating the point of time at which FFT is started includes: a step of receiving signals from the excluded second node requested to change the point of time at which the signal is transmitted and the remaining second nodes not excluded, at the second point of time; a third step of excluding at least one of the second nodes that have transmitted the signals received at the second point of time when the signals received at the second point of time do not satisfy the first condition; and a step of changing the point of time at which FFT is started using a point of time at which the signal transmitted by at least one of remaining second nodes not excluded in the third step is received.

The step of updating the point of time at which FFT is started includes: a fourth step of excluding any one of remaining second nodes not excluded in the third step when the changed point of time at which FFT is started is within the switching interval; a step of changing the point of time at which FFT is started again using a point of time at which the signal transmitted by at least any one of remaining second nodes not excluded in the fourth step is received; and a step of requesting the second nodes, excluded in the third step and the fourth step, to change points of time at which signals are transmitted.

Furthermore, another embodiment of the present invention provides a method of a first node synchronizing transmission times in a wireless network. The synchronization method includes the steps of: receiving change request messages for points of time at which signals are transmitted from a plurality of second nodes adjacent to the first node; changing the points of time at which the signals are transmitted in response to the change request message; and sending change values of the points of time at which the signals are transmitted to the plurality of second nodes.

Furthermore, yet another embodiment of the present invention provides a first node in a multi-carrier system. The first node includes a reception processor for receiving a first preamble signal from an adjacent second node, receiving a second preamble signal from an adjacent third node, and receiving a third preamble signal from an adjacent fourth node; a first selection processor for selecting the second node when a difference between points of time at which an earliest arrived signal and a last arrived signal of the first to the third preamble signals are received is greater than a length of a cyclic prefix (CP) of one symbol; an FFT start time point setting processor for setting a point of time at which fast Fourier transform (FFT) is started using a point of time at which the second preamble signal is received when a difference between points of time at which the second and the third preamble signals are received is smaller than the length of the CP; and a transmission processor for sending a message, requesting the second node to change a point of time at which a signal is transmitted, to the second node.

### BRIEF DESCRIPTION OF THE DRAWINGS

FIG. 1 is a diagram showing adjacent nodes in a wireless network.

FIG. 2 is a flowchart illustrating a time synchronization method in accordance with an exemplary embodiment of the present invention.

FIG. 3 is a diagram showing a switching gap between frames transmitted and received by a node.

FIG. 4 is a diagram showing a node in a wireless network system or a multi-carrier system in accordance with an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

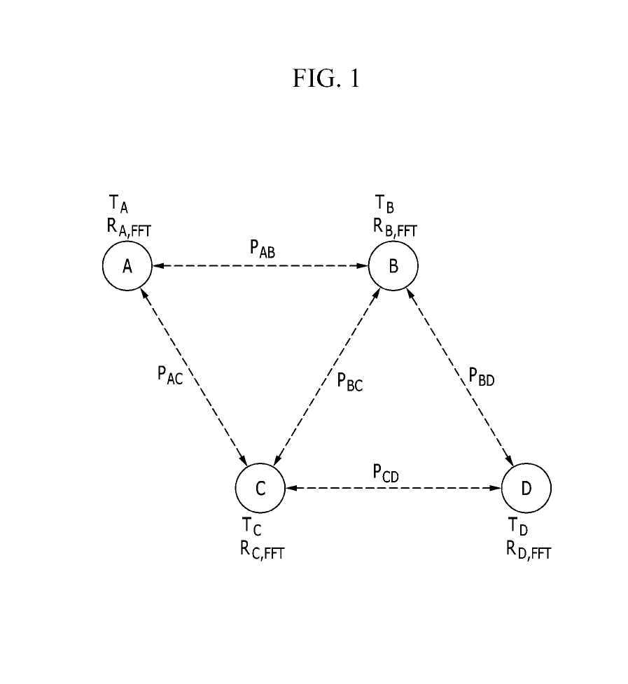

FIG. 1 is a diagram showing adjacent nodes in a wireless network. In FIG. 1, a specific node C and three adjacent nodes A, B, and D within one hop on the basis of the specific node C are illustrated, for convenience sake.

T_{A}, T_{B}, T_{C}, and T_{D} indicate respective points of time at which the nodes A, B, C, and D transmit signals, and R_{A,FFT}, R_{B,FFT}, R_{C,FFT}, and R_{D,FFT} indicate respective points of time at which the nodes A, B, C, and D start fast Fourier transform (FFT). Distance delay times P_{AC}, P_{AB}, P_{BC}, P_{BC}, and P_{CD} indicate delay times according to the distances between nodes. For example, the distance delay time P_{AC} is a delay time according to the distance between the node C and the node A, and a value of the distance delay time P_{AC} corresponds to half the RTD between the node C and the node A, that is, RTD_{AC}/2. Meanwhile, the present invention does not include a process of estimating the distance delay times P_{AC}, P_{AB}, P_{BC}, P_{BC}, and P_{CD}, and RTD.

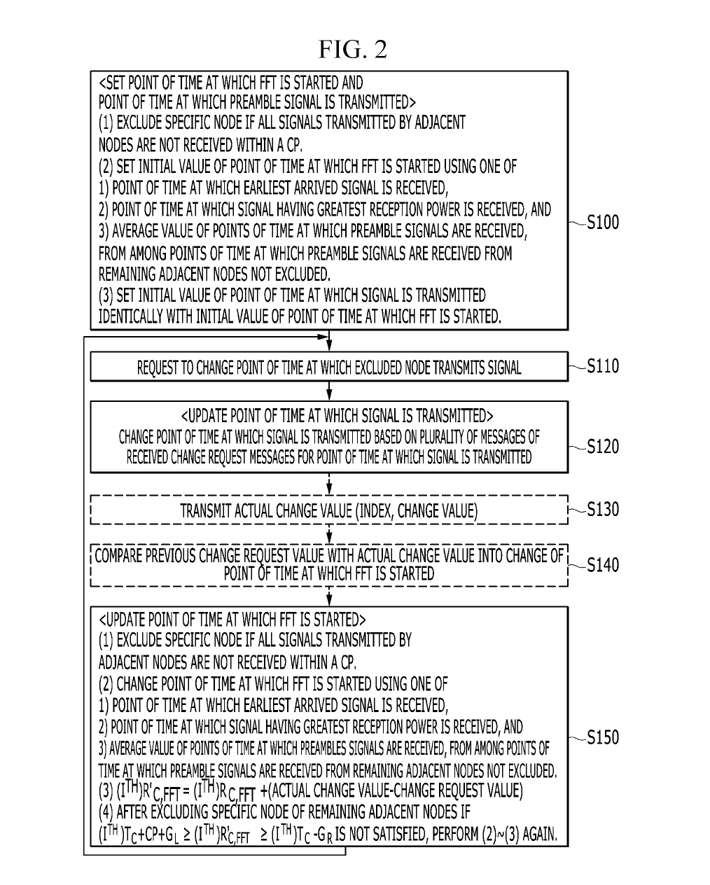

FIG. 2 is a flowchart illustrating a time synchronization method in accordance with an exemplary embodiment of the present invention. The time synchronization method is described on the basis of the specific node C, for convenience of description.

The nodes A, B, C, and D send preamble signals so that a node receiving the preamble signal can perform synchronization at a point of time at which FFT is started and a point of time at which a signal is transmitted.

First, the specific node C sets initial values for a point of time at which FFT is started and a point of time at which a signal is transmitted using the preamble signals received from the adjacent nodes A, B, and D at step S100. The node C calculates points of time at which the preamble signals transmitted by the adjacent nodes A, B, and D are received. Here, a point of time R_{CA} at which the preamble signal transmitted by the node A is received corresponds to T_{A}+P_{AC} in the existing synchronization method, a point of time R_{CB} at which the preamble signal transmitted by the node B is received corresponds to T_{B}+P_{BC} in the existing synchronization method, and a point of time R_{CD} at which the preamble signal transmitted by the node D is received corresponds to T_{D}+P_{CD} in the existing synchronization method.

The specific node C determines whether or not the preamble signals received from the adjacent nodes A, B, and D satisfy a first condition defined in Equation 1 below.

|R_{MAX}−R_{MIN}|≦CP (Equation 1)

(R_{MAX}: the earliest arrived signal of the received preamble signals, R_{MIN}: the last arrived signal of the received preamble signals, and CP: the length of a cyclic prefix (CP) of one symbol)

If, as a result of the determination, it is determined that the first condition is satisfied, a point of time R_{C,FFT} at which the node C starts FFT is set using one method corresponding to a set item (hereinafter referred to as an “S50 process”), from among the following methods (1) to (3).

(1) A point of time at which the earliest arrived signal is received+CP, (2) a point of time at which a signal having the greatest reception power is received+CP, and (3) an average value of points of time at which the received signals are received.

More particularly, if the set item corresponds to the method (1), a value obtained by adding a CP to a point of time at which the earliest arrived signal, from among the preamble signals received by the node C, is received is set as an initial value of the point of time R_{C,FFT} at which FFT is started. For example, if the preamble signal transmitted by the node A has arrived earliest, the point of time R_{C,FFT} at which FFT is started=R_{CA}+CP.

Furthermore, if the set item corresponds to the method (2), a value obtained by adding a CP to a point of time at which a signal having the greatest reception power, from among the preamble signals received by the node C, is received is set as an initial value of the point of time R_{C,FFT} at which FFT is started. For example, if the reception power of the preamble signal transmitted by the node A is the greatest, the point of time R_{C,FFT} at which FFT is started=R_{CA}+CP.

Furthermore, if the set item corresponds to the method (3), a value obtained by adding a CP to an average value of points of time at which all the preamble signals received by the node C are received is set as an initial value of the point of time R_{C,FFT} at which FFT is started. For example, the point of time R_{C,FFT} at which FFT is started=(R_{CA}+R_{CB}+R_{CD})/3+CP.

Meanwhile, if, as a result of the determination, it is determined that the first condition is not satisfied, that is, |R_{MAX}−R_{MIN}|>CP, some nodes of the adjacent nodes A, B, and D are excluded (hereinafter referred to as an “S60 process”). A node to be excluded is selected using one method corresponding to a set item, from among the following methods (1) to (3).

(1) A node that has transmitted the last arrived signal is excluded, (2) a node that has transmitted a signal having the weakest reception power is excluded, and (3) a node that has transmitted a signal having the greatest difference between a value of a point of time at which a preamble signal transmitted by the corresponding node is received and an average value of points of time at which preamble signals transmitted by the remaining nodes are received is excluded.

More particularly, if the set item corresponds to the method (1), a node that has transmitted the last arrived signal, from among the preamble signals received by the node C, is excluded. For example, if the preamble signal transmitted by the node B has reached the node C, the node B is excluded.

Furthermore, if the set item corresponds to the method (2), a node that has transmitted a preamble signal having the weakest reception power, from among the preamble signals received by the node C, is excluded. For example, if the reception power of the preamble signal transmitted by the node B is the weakest, the node B is excluded.

Furthermore, if the set item corresponds to the method (3), a node that has transmitted a preamble signal having the greatest difference between a point of time at which a preamble signal transmitted by the corresponding node is received and an average value of points of time at which the preamble signals received by the node C are received is excluded. For example, if a difference between an average value of points of time at which all the preamble signals received by the node C are received and a point of time at which the preamble signal transmitted by the node B is received, that is, |R_{CB}−(R_{CA}+R_{CA}+R_{CA})/3|, is the greatest, the node B is excluded.

The node C determines whether or not the first condition is satisfied regarding the remaining nodes A and D excluding a node (e.g., B) of the adjacent nodes A, B, and D. That is, the node C determines whether or not a difference between points of time at which the preamble signals transmitted by the nodes A and D are received is within a CP. If, as a result of the determination, it is determined that the first condition is not satisfied, a node of the adjacent nodes A and D is excluded through the S60 process. The S60 process is repeated until the first condition is satisfied.

If remaining adjacent nodes (e.g., A and D) satisfy the first condition without being excluded by the S60 process, an initial value of the point of time R_{C,FFT} at which the node C starts FFT is set through the S50 process for the adjacent nodes A and D. Furthermore, an initial value of a point of time at which the node C performs transmission is set to be identical with an initial value of the point of time R_{C,FFT} at which the node C starts FFT.

The node C transmits a message, requesting the excluded nodes to change points of time at which the excluded nodes transmit signals, to the excluded nodes at step S110. More particularly, the node C determines whether a point of time at which the preamble signal transmitted by an excluded node is received is earlier or later than a point of time at which the preamble signal transmitted by any one of the remaining nodes not excluded by the S60 process is received, and transmits a transmission time point change request message to the excluded node. More particularly, the node C generates the transmission time point change request message on the basis of a point of time at which the preamble signal is received, which was used to set the point of time R_{C,FFT} at which FFT is started in the S50 process. For example, assuming that a node left without being excluded by the S60 process is the node A and excluded nodes are the nodes B and D, if a point of time at which the preamble signal transmitted by the node B is received is earlier than a point of time at which the preamble signal transmitted by the node A is received, the node C sends a message, requesting to delay the point of time at which a signal is transmitted, to the node B. If a point of time at which the preamble signal transmitted by the node B is received is later than a point of time at which the preamble signal transmitted by the node A is received, the node C sends a message, requesting to advance a point of time at which a signal is transmitted, to the node B. Like in the node D, if a point of time at which the preamble signal transmitted by the node D is received is earlier than a point of time at which the preamble signal transmitted by the node A is received, the node C sends a message, requesting to delay a point of time at which a signal is transmitted, to the node D. If a point of time at which the preamble signal transmitted by the node D is received is later than a point of time at which the preamble signal transmitted by the node A is received, the node C sends a message, requesting to advance a point of time at which a signal is transmitted, to the node D. Meanwhile, if nodes left without being excluded by the S60 process are the nodes A and B, an excluded node is the node D, and the point of time R_{C,FFT} at which FFT is started has been set using the point of time R_{CB} at which the preamble signal transmitted by the node B is received, the node C generates a transmission time point change request message on the basis of the point of time R_{CB} at which the preamble signal transmitted by the node B is received and transmits the generated message to the node D.

In response to the transmission time point change request message, a node changes a point of time at which the node transmits the preamble signal in response to a plurality of messages, from among received transmission time point change request messages, at step S120.

Points of time at which the nodes A, B, C, and D transmit the preamble signals are periodically updated. More particularly, a node (e.g., B) receives transmission time point change request messages, transmitted by adjacent nodes (e.g., A, C, and D) at an (i−1)^{th} update time, at an i^{th} update time, and changes a point of time at which the node B transmits the preamble signal in response to the received transmission time point change request messages. Here, a (t0)^{th} update time means the time when initial values of a point of time at which a signal is transmitted and a point of time at which FFT is started according to the step S100 are set. If the number of first messages requesting to advance a point of time at which a signal is transmitted, from among transmission time point change request messages received by the node B, is larger than the number of second messages requesting to delay a point of time at which a signal is transmitted, a point of time at which a signal is transmitted is advanced. That is, T_{B,i}=T_{B,i-1}−Δ. Furthermore, if the number of second messages is larger than the number of first messages, the node B delays a point of time at which a signal is transmitted. That is, T_{B,i}=T_{B,i-1}+Δ. Furthermore, the number of first messages is identical with the number of second messages, the node B maintains a point of time at which a signal is transmitted without changing the point of time. That is, T_{B,i}=T_{B,i-1}. Here, when ti=1, T_{B,0} means an initial value of a point of time at which the node B transmits the preamble signal, and Δ may be a fixed value or a value that is gradually increased every update time. Points of time at which the nodes A, C, and D transmit the preamble signals are updated as described above.

A node which has changed a point of time at which a signal is transmitted transmits an actual change value of a point of time at which a signal is transmitted to adjacent nodes at step S130. For example, a node (e.g., B) which has changed a point of time at which a signal is transmitted at an i^{th} update time transmits the data field of a packet, including an actual change value Δ of a point of time at which the preamble signal and an index (e.g., an index indicative of the node B), to the adjacent nodes A, C, and D.

A node incorporates a difference between a request change value of a point of time at which a signal is transmitted, transmitted to an adjacent node at an (i−1)^{th} update time, and an actual change value Δ of a point of time at which a signal is transmitted, received from the adjacent node, into a change of a point of time at which FFT is started at an (i+1)^{th} update time at step S140. For example, if the node C has received an actual change value Δ of a point of time at which a signal is transmitted from the node B at an (i+1)^{th} update time (e.g., a third update time), the node C calculates a difference between a request change value of a point of time at which a signal is transmitted, transmitted to the node B at an (i−1)^{th} update time (e.g., a first update time), and the received actual change value Δ of the point of time at which a signal is transmitted. The difference is incorporated into a point of time at which FFT is started is changed at step S150. This is described in detail along with the step S150.

Points of time at which the nodes A, B, C, and D start FFT are periodically updated. More particularly, a node (e.g., C) receives the preamble signals from adjacent nodes (e.g., A, B, and D) between an (i−1)^{th} update time and an i^{th} update time, and updates a point of time (e.g., R_{C,FFT}) at which FFT is started in response to the preamble signals at step S150. Here, an i^{th} update of a point of time (e.g., R_{C,FFT}) at which FFT is started is performed irrespective of an (i−1)^{th} updated point of time R_{C,FFT} at which FFT is started. More particularly, first, the node C performs the S50 and S60 processes using points of time at which the preamble signals received from the adjacent nodes A, B, and D are received. That is, the node C excludes a node (e.g., D) of the adjacent nodes A, B, and D until the preamble signals transmitted by the adjacent nodes A, B, and D satisfy the first condition (the S60 process). Furthermore, the node C changes the point of time R_{C,FFT} at which FFT is started using points of time at which the preamble signals transmitted by the remaining adjacent nodes (e.g., A and B), satisfying the first condition and not excluded, are received (the S50 process). For example, if a signal transmitted by the node A, from among the signals transmitted by the remaining adjacent nodes A and B, is first reached, the node C changes the point of time R_{C,FFT} at which FFT is started into “R_{CA}+CP”. Meanwhile, at an (i+1)^{th} update time, a node (e.g., C) incorporates “the difference between an actual change value of a point of time at which a signal is transmitted and a change request value of a point of time at which a signal is transmitted”, calculated at step S140, into the changed point of time R_{C,FFT} at which FFT is started. For example, assuming that the node C had requested the node B to change a point of time at which a signal is transmitted by +Δ at an (i−1)^{th} update time (e.g., a first update time), but the node B has changed the point of time at which a signal is transmitted by 0 at an i^{th} update time (e.g., a second update time), the node C adds (0−Δ) to the changed point of time R_{C,FFT} at which FFT is started at an (i+1)^{th} update time (e.g., a third update time). That is, R′_{C,FFT}=R_{C,FFT}+(0−Δ). Meanwhile, if the node C had requested the node B and the node D to change respective points of time at which the preamble signals are transmitted by +Δ1 and +Δ2 at an (i−1)^{th} update time (e.g., a first update time), but the node B and the node D have changed the points of time at which the preamble signals are transmitted by 0 and +Δ3, respectively, at an i^{th} update time (e.g., a second update time), the node C adds “{(0−Δ1)+(Δ3−Δ2)}/2” to the changed point of time R_{C,FFT} at which FFT is started at an (i+1)^{th} update time (e.g., a third update time). That is, R_{C,FFT}=R_{C,FFT}+{(0−Δ1)+(Δ3−Δ2)}/2.

Furthermore, the node C determines whether or not the i^{th} point of time R_{C,FFT} or R′_{C,FFT} at which FFT is started satisfies a second condition defined by Equation 2 below. Meanwhile, if the point of time R′_{C,FFT} at which FFT is started into which “the difference between an actual change value of a point of time at which a signal is transmitted and a change request value of a point of time at which a signal is transmitted”, calculated at step S140, has been incorporated does not satisfy the second condition, the node C determines whether or not the second condition is satisfied using the point of time R_{C,FFT} at which FFT is started into which “the difference between an actual change value of a point of time at which a signal is transmitted and a change request value of a point of time at which a signal is transmitted”, calculated at step S140, has not been incorporated as the point of time R_{C,FFT} at which FFT is started (i.e., R′_{C,FFT}=R_{C,FFT}).

(i^{th})T_{C}+CP+G_{L}≧(i^{th})R′_{C,FFT}≧(i^{th})T_{C}−G_{R} (Equation 2)

(G_{L}: the length of a first guard interval and G_{R}: the length of a second guard interval)

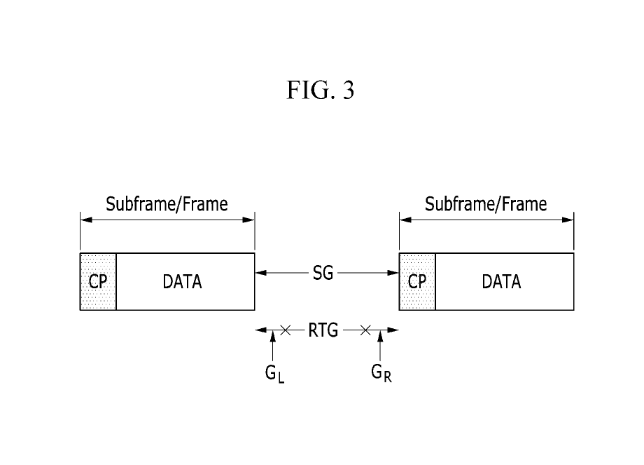

In Equation 2, each of G_{L} and G_{R} indicates an additional guard interval between subframes (or frames) shown in FIG. 3. More particularly, a switching gap (SG) between the subframes (or frames) includes a first guard interval G_{L}, a second guard interval G_{R}, and RTG. G_{L} is a first guard interval necessary to delay a point of time at which a signal is transmitted (or a point of time at which the preamble signal is received) in the GP between the subframes (or frames), and G_{R} is a second guard interval necessary to advance a point of time at which a signal is transmitted (or a point of time at which the preamble signal is received) in the GP between the subframes (or frames). Furthermore, RTG is a switching interval necessary to switch from transmission to reception or from reception to transmission. Only the CP and the data field forming a symbol (e.g., OFDM symbol) are illustrated in FIG. 3, but the frame can include a preamble and a plurality of symbols. Meanwhile, the i^{th} point of time R′_{C,FFT} at which FFT is started should not be placed within the RTG interval.

If a point of time (e.g., R′_{C,FFT}) at which a node starts FFT does not satisfy the second condition, the node C performs the S50 process again excluding a specific node of the remaining adjacent nodes as in the S60 process. Furthermore, the node C determines whether or not the changed point of time R′_{C,FFT} at which FFT is started satisfies the second condition. That is, the S50 and S60 processes are repeated until the changed point of time R′_{C,FFT} at which FFT is started satisfies the second condition.

The step S150 is described in detail below. For convenience of description, it is assumed that the point of time R_{C,FFT} at which FFT is started is set according to the method (1) in the S50 process and a specific node is excluded according to the method (1) in the S60 process.

First, the node C receives the preamble signals from the adjacent nodes A, B, and D.

The node C determines whether the received preamble signals satisfy the first condition or not. If, as a result of the determination, it is determined that the first condition is not satisfied, the node C excludes a node (e.g., B) that has transmitted the last arrived signal from the adjacent nodes A, B, and D.

The node C determines whether or not the preamble signals transmitted by the adjacent nodes A and D satisfy the first condition. If, as a result of the determination, it is determined that the first condition is satisfied, the node C changes the point of time R_{C,FFT} at which FFT is started into a value obtained by adding a CP to a point of time at which the earliest arrived signal (e.g., the preamble signal transmitted by the node A), from among the preamble signals transmitted by the adjacent nodes A and D, is received. That is, R_{C,FFT}=R_{CA}+CP.

The node C incorporates a difference between a change request value (e.g., +Δ) of a point of time at which a signal is transmitted that the node C has requested an excluded node (e.g., B) to change at a previous update time (e.g., a first update time) and an actual change value of a point of time at which the preamble signal transmitted by the node B at a current update time (e.g., a third update time) is transmitted (e.g., an actual change value (e.g., 0) of a point of time at which a signal is transmitted, changed by the node B at a second update time) into the point of time R_{C,FFT} at which FFT is started. That is, R′_{C,FFT}=R_{C,FFT}+(0−Δ). If the node C has not received the actual change value of the point of time at which a signal is transmitted from the node B, the node C uses the point of time R_{C,FFT} at which FFT is started as a point of time R_{C,FFT} at which FFT is started. That is, R′_{C,FFT}=R_{C,FFT}.

The node C determines whether the point of time R′_{C,FFT} at which FFT is started satisfies the second condition or not. If the point of time R′_{C,FFT} at which FFT is started into which “the difference between an actual change value of a point of time at which a signal is transmitted and a change request value of a point of time at which a signal is transmitted”, calculated at step S140, has been incorporated does not satisfy the second condition, the node C determines whether or not the point of time R_{C,FFT} at which FFT is started into which “the difference between an actual change value of a point of time at which a signal is transmitted and a change request value of a point of time at which a signal is transmitted”, calculated at step S140, has not been incorporated satisfies the second condition. If, as a result of the determination, it is determined that the second condition is not satisfied, a node (e.g., D) that has transmitted the last arrived signal is excluded from the remaining adjacent nodes A and D. Furthermore, the node C changes the point of time R_{C,FFT} at which FFT is started into a value obtained by adding a CP to a point of time at which the preamble signal transmitted by the node A is not excluded is received. Furthermore, the node C incorporates a difference between the change request value (e.g., +Δ) of the point of time at which the node B transmits the preamble signal, previously calculated, and the actual change value 0 of the point of time at which a signal is transmitted into the point of time R_{C,FFT} at which FFT is started. That is, R′_{C,FFT}=R_{C,FFT}+(0−Δ). The above process is repeated until the changed point of time R′_{C,FFT} at which FFT is started satisfies the second condition.

Meanwhile, the steps S130 and S140 may be omitted. That is, the synchronization method according to the present invention may be performed as in step S100->step S110->step S120->step S150->step S110->step S120->150->110 . . . .

Meanwhile, the S50 and S60 processes may be designed as follows. In the S50 process, a point of time (e.g., R_{C,FFT}) at which FFT is started can be set according to one method corresponding to a set item, from among the following methods (1) to (3).

(1) A point of time at which the last arrived signal is received+CP, (2) a point of time at which a preamble signal having the weakest reception power is received+CP, and (3) an average value of points of time at which preambles signals are received.

Furthermore, in the S60 process, a node to be excluded can be selected according to one method corresponding to a set item, from among the following methods (1) to (3).

(1) A node that has transmitted the earliest arrived signal is excluded, (2) a node that has transmitted a signal having the strongest reception power is excluded, and (3) a node that has transmitted a signal having the greatest difference between a point of time at which the corresponding node transmits a signal and an average value of points of time at which signals transmitted by remaining nodes are received.

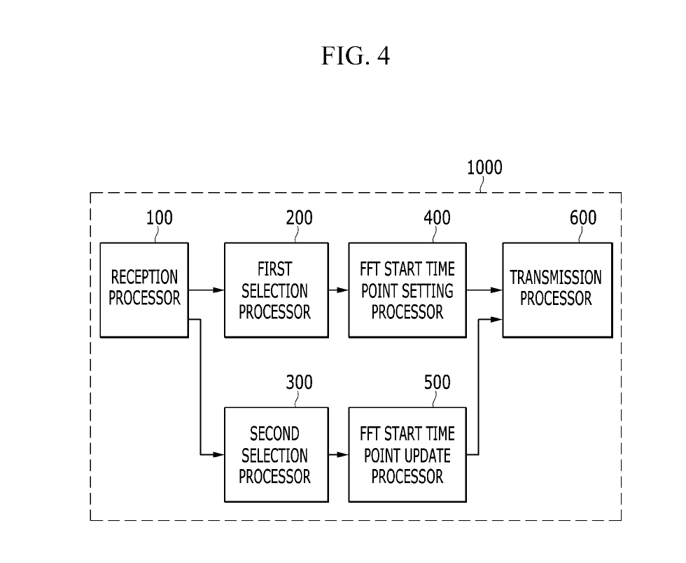

FIG. 4 is a diagram showing a node 1000 (e.g., C) in a wireless network system or a multi-carrier system in accordance with an embodiment of the present invention. The node 1000 performs the operation for time synchronization which has been described with reference to FIGS. 1 to 3.

The node 1000 includes a reception processor 100, a first selection processor 200, a second selection processor 300, an FFT start time point setting processor 400, an FFT start time point update processor 500, and a transmission processor 600.

The reception processor 100 receives preamble signals from adjacent nodes (e.g., A, B, and D).

The first selection processor 200 determines whether or not the preamble signals received by the reception processor 100 satisfy the first condition and selects at least one node (e.g., B) from the adjacent nodes A, B, and D if, as a result of the determination, it is determined that the first condition is not satisfied.

The FFT start time point setting processor 400 sets initial values of the FFT start time point R_{C,FFT} and the transmission time point using the preamble signals which have been received from the adjacent nodes (e.g., A and D) and not been selected by the first selection processor 200. The first selection processor 200 and the FFT start time point setting processor 400 perform an operation corresponding to step S100 of FIG. 2.

The second selection processor 300 determines whether or not the FFT start time point R_{C,FFT} or R′_{C,FFT} satisfies the second condition and selects at least one node (e.g., D) from the adjacent nodes (e.g., A and D) if, as a result of the determination, it is determined that the second condition is not satisfied.

The FFT start time point update processor 500 updates the FFT start time point R_{C,FFT} or R′_{C,FFT} and the transmission time point using the preamble signal which has been received from the adjacent nodes (e.g., A) and not been selected by the second selection processor 300. The second selection processor 300 and the FFT start time point update processor 500 perform an operation corresponding to step S150 of FIG. 2.

The transmission processor 600 sends a message, requesting a point of time at which a signal is transmitted to be changed, to a node (e.g., B) selected by the first selection processor 200 or the second selection processor 300. The transmission processor 600 performs an operation corresponding to step S110 of FIG. 2.

In accordance with the present invention, a point of time at which a specific node starts FFT and a point of time at which the specific node performs transmission are determined based on points of time at which signals are received from adjacent nodes, and the point of time at which FFT is started and the point of time at which transmission is performed are changed through a transmission time point change request between nodes. Accordingly, unlike in an existing synchronization method, time synchronization between nodes can be performed using a simple method without a ranging process, an RTD estimation process, and a frame start time point setting process.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of a first node synchronizing reception times in a wireless network, the method comprising steps of:
receiving signals from a plurality of second nodes adjacent to a first node at a first point of time;
excluding at least one of the plurality of second nodes when a difference between points of time at which the signals are received from the plurality of second nodes is greater than a length of a cyclic prefix (CP) of one symbol;
setting an initial value of a point of time at which fast Fourier transform (FFT) is started using a point of time at which the signal transmitted by at least any one of remaining second nodes not excluded in the excluding step is received;
requesting the second node, excluded in the excluding step, to change a point of time at which a signal is transmitted; and
receiving signals from the excluded second node requested to change a point of time at which a signal is transmitted and the remaining second nodes not excluded at a second point of time and updating the point of time at which FFT is started.

2. The method of claim 1, wherein the excluding step comprises:
a first step of excluding any one of a node that has transmitted the last arrived signal, a node that has transmitted a signal having a weakest reception power, and a node that has transmitted a signal having a greatest difference between a point of time at which the signal transmitted by the node is received and an average value of points of time at which the received signals are received, from among the second nodes that have transmitted the received signals, when a first condition defining whether a difference between a point of time at which a earliest arrived signal, from among the received signals, is received and a point of time at which the last arrived signal is received is smaller than or equal to a length of the CP is not satisfied; and
a second step of repeatedly performing the first step on signals received from remaining second nodes not excluded in the first step until the first condition is satisfied.

3. The method of claim 1, wherein the excluding step comprises:
a first step of excluding any one of a node that has transmitted an earliest arrived signal, a node that has transmitted a signal having a strongest reception power, and a node that has transmitted a signal having a greatest difference between a point of time at which the signal transmitted by the node is received and an average value of points of time at which the received signals are received, from among the second nodes that have transmitted the received signals, when a first condition defining whether a difference between a point of time at which the earliest arrived signal, from among the received signals, is received and a point of time at which a last arrived signal is received is smaller than or equal to a length of the CP is not satisfied; and
a second step of repeatedly performing the first step on signals received from remaining second nodes not excluded in the first step until the first condition is satisfied.

4. The method of claim 2, wherein the step of setting an initial value of a point of time at which fast Fourier transform (FFT) is started comprises steps of:
setting any one of a value obtained by adding the length of the CP to a point of time at which an earliest arrived signal, from among signals transmitted by remaining second nodes, not excluded and satisfying the first condition, is received, a value obtained by adding the length of the CP to a point of time at which a signal having strongest reception power, from among the signals transmitted by the remaining second nodes, not excluded and satisfying the first condition, is received, and a value obtained by adding the length of the CP to an average value of points of time at which the signals transmitted by the remaining second nodes, not excluded and satisfying the first condition, are received as the initial value of the point of time at which FFT is started; and
setting an initial value of a point of time at which a signal is transmitted identically with the initial value of the point of time at which FFT is started.

5. The method of claim 3, wherein the step of setting an initial value of a point of time at which fast Fourier transform (FFT) is started comprises steps of:
setting any one of a value obtained by adding the length of the CP to a point of time at which a last arrived signal, from among signals transmitted by remaining second nodes, not excluded and satisfying the first condition, is received, a value obtained by adding the length of the CP to a point of time at which a signal having weakest reception power, from among the signals transmitted by the remaining second nodes, not excluded and satisfying the first condition, is received, and a value obtained by adding the length of the CP to an average value of points of time at which the signals transmitted by the remaining second nodes, not excluded and satisfying the first condition, are received as the initial value of the point of time at which FFT is started; and
setting an initial value of a point of time at which a signal is transmitted identically with the initial value of the point of time at which FFT is started.

6. The method of claim 4, wherein the step of requesting the second node, excluded in the excluding step, to change the point of time at which the signal is transmitted, comprises sending a message instructing the excluded second node to delay a point of time at which a signal is transmitted when the point of time at which the signal transmitted by the excluded second node is received is earlier than a point of time at which a signal transmitted by any one of the remaining second nodes, not excluded and satisfying the first condition, is received to the excluded second node, and sending a message instructing the excluded second node to advance a point of time at which a signal is transmitted when the point of time at which the signal transmitted by the excluded second node is received is later than a point of time at which a signal transmitted by any one of the remaining second nodes, not excluded and satisfying the first condition, is received to the excluded second node.

7. The method of claim 6, wherein:
a switching gap between frames transmitted or received by the first node comprises a first guard interval, a second guard interval, and a switching interval;
the first guard interval is an interval in which a point of time at which a signal is transmitted or a point of time at which a signal is received is delayed;
the second guard interval is an interval in which a point of time at which a signal is transmitted or a point of time at which a signal is received is advanced; and
the switching interval is placed between the first and second guard intervals and is an interval in which transmission is switched into reception or from reception to transmission.

8. The method of claim 7, wherein the step of updating the point of time at which FFT is started comprises:
a step of receiving signals from the excluded second node requested to change the point of time at which the signal is transmitted and the remaining second nodes not excluded, at the second point of time;
a third step of excluding at least one of the second nodes that have transmitted the signals received at the second point of time when the signals received at the second point of time do not satisfy the first condition; and
a step of changing the point of time at which FFT is started using a point of time at which the signal transmitted by at least one of remaining second nodes not excluded in the third step is received.

9. The method of claim 8, wherein the step of updating the point of time at which FFT is started comprises:
a fourth step of excluding any one of remaining second nodes not excluded in the third step when the changed point of time at which FFT is started is within the switching interval;
a step of changing the point of time at which FFT is started again using a point of time at which the signal transmitted by at least any one of remaining second nodes not excluded in the fourth step is received; and
a step of requesting the second nodes, excluded in the third step and the fourth step, to change points of time at which signals are transmitted.

10. The method of claim 8, wherein the step of updating the point of time at which FFT is started comprises:
a fourth step of excluding any one of remaining second nodes not excluded in the third step when the changed point of time at which FFT is started does not satisfy a second condition defined by an equation below;
a step of changing the point of time at which FFT is started again using a point of time at which the signal transmitted by at least one of remaining second nodes not excluded in the fourth step is received; and
a step of requesting the second nodes, excluded in the third step and the fourth step, to change points of time at which signals are transmitted:
T₁−G_{R}≦R_{1, FFT}≦T₁+CP+G_{L} [Equation]
(R_{1, FFT}: the point of time at which the first node starts FFT, T₁: a point of time at which the first node transmits a signal, G_{L}: a length of the first guard interval, and G_{R}: a length of the second guard interval).

11. The method of claim 10, wherein:
the third step comprises
a fifth step of excluding any one of a node that has transmitted a last arrived signal, a node that has transmitted a signal having weakest reception power, and a node that has transmitted a signal having a greatest difference between a point of time at which the signal transmitted by the node is received and an average value of points of time at which the signals are received, from among the second nodes that have transmitted the signals received at the second point of time, when the signals received at the second point of time do not satisfy the first condition, and
a step of repeatedly performing the fifth step on signals received from remaining second nodes not excluded in the fifth step until the first condition is satisfied; and
the fourth step comprises a step of excluding any one of a node that has transmitted a last arrived signal, a node that has transmitted a signal having weakest reception power, and a node that has transmitted a signal having a greatest difference between a point of time at which the signal transmitted by the node is received and an average value of points of time at which the signals are received, from among remaining second nodes not excluded in the third step, when the changed point of time at which FFT is started does not satisfy the second condition.

12. The method of claim 11, wherein:
the step of changing the point of time at which FFT is started comprises a step of changing the point of time at which FFT is started into any one of a value in which the length of the CP is added to a point of time at which an earliest arrived signal, from among the signals transmitted by remaining second nodes not excluded in the third step, is received, a value in which the length of the CP is added to a point of time at which a signal having strongest reception power, from among the signals transmitted by remaining second nodes not excluded in the third step, is received, and a value in which the length of the CP is added to an average value of points of time at which signals transmitted by the remaining second nodes not excluded in the third step are received; and
the step of changing the point of time at which FFT is started again comprises a step of changing the point of time at which FFT is started into any one of a value in which the length of the CP is added to a point of time at which an earliest arrived signal, from among the signals transmitted by remaining second nodes not excluded in the fourth step, is received, a value in which the length of the CP is added to a point of time at which a signal having strongest reception power, from among the signals transmitted by remaining second nodes not excluded in the fourth step, is received, and a value in which the length of the CP is added to an average value of points of time at which signals transmitted by the remaining second nodes not excluded in the fourth step are received.

13. The method of claim 10, wherein:
the third step comprises
a fifth step of excluding any one of a node that has transmitted an earliest arrived signal, a node that has transmitted a signal having strongest reception power, and a node that has transmitted a signal having a greatest difference between a point of time at which the signal transmitted by the node is received and an average value of points of time at which the signals are received, from among the second nodes that have transmitted the signals received at the second point of time, when the signals received at the second point of time do not satisfy the first condition, and
a step of repeating performing the fifth step on the signals received from remaining second nodes not excluded in the fifth step until the first condition is satisfied; and
the fourth step comprises a step of excluding any one of a node that has transmitted an earliest arrived signal, a node that has transmitted a signal having strongest reception power, and a node that has transmitted a signal having a greatest difference between a point of time at which the signal transmitted by the node is received and an average value of points of time at which the signals are received, from among remaining second nodes not excluded in the third step, when the changed point of time at which FFT is started does not satisfy the second condition.

14. The method of claim 10, wherein the step of updating the point of time at which FFT is started comprises a step of comparing a change request value of a point of time at which a signal is transmitted, requested from the second node excluded at the first point of time, with an actual change value of a point of time at which a signal is transmitted, transmitted by the second node excluded at the first point of time, and incorporating a result of the comparison into the point of time at which FFT is started, changed in the step of changing the point of time at which FFT is started, before the fourth step.

15. The method of claim 13, wherein:
the step of changing the point of time at which FFT is started comprises a step of changing the point of time at which FFT is started into any one of a value in which the length of the CP is added to a point of time at which a last arrived signal, from among the signals transmitted by remaining second nodes not excluded in the third step, is received, a value in which the length of the CP is added to a point of time at which a signal having weakest reception power, from among the signals transmitted by remaining second nodes not excluded in the third step, is received, and a value in which the length of the CP is added to an average value of points of time at which signals transmitted by the remaining second nodes not excluded in the third step are received; and
the step of changing the point of time at which FFT is started again comprises a step of changing the point of time at which FFT is started into any one of a value in which the length of the CP is added to a point of time at which a last arrived signal, from among the signals transmitted by remaining second nodes not excluded in the fourth step, is received, a value in which the length of the CP is added to a point of time at which a signal having weakest reception power, from among the signals transmitted by remaining second nodes not excluded in the fourth step, is received, and a value in which the length of the CP is added to an average value of points of time at which signals transmitted by the remaining second nodes not excluded in the fourth step are received.

16. A method of a first node synchronizing transmission times in a wireless network, the method comprising steps of:
receiving change request messages for points of time at which signals are transmitted from a plurality of second nodes adjacent to the first node;
changing the points of time at which the signals are transmitted in response to the change request message; and
sending change values of the points of time at which the signals are transmitted to the plurality of second node.

17. The method of claim 16, wherein the step of changing the points of time at which the signals are transmitted comprises a step of advancing the points of time at which the signals are transmitted by a set value when a number of first messages instructing the points of time at which the signals are transmitted to be advanced, from among the change request messages for the points of time at which the signals are transmitted, is larger than a number of second messages instructing the points of time at which the signals are transmitted to be delayed, delaying the points of time at which the signals are transmitted by a set value when the number of second messages instructing the points of time at which the signals are transmitted to be delayed is larger than the number of first messages instructing the points of time at which the signals are transmitted to be advanced, and maintaining the points of time at which the signals are transmitted when the number of first messages is identical with the number of second messages.

18. A first node in a multi-carrier system, comprising:
a reception processor for receiving a first preamble signal from an adjacent second node, receiving a second preamble signal from an adjacent third node, and receiving a third preamble signal from an adjacent fourth node;
a first selection processor for selecting the second node when a difference between points of time at which an earliest arrived signal and a last arrived signal of the first to the third preamble signals are received is greater than a length of a cyclic prefix (CP) of one symbol;
an FFT start time point setting processor for setting a point of time at which fast Fourier transform (FFT) is started using a point of time at which the second preamble signal is received when a difference between points of time at which the second and the third preamble signals are received is smaller than the length of the CP; and
a transmission processor for sending a message, requesting the second node to change a point of time at which a signal is transmitted, to the second node.

19. The first node of claim 18, wherein:
the first preamble signal is a signal arrived later than the second and the third preamble signals or a signal having weaker reception power than the second and the third preamble signals,
the second preamble signal is a signal arrived earlier than the third preamble signal or a signal having stronger reception power than the third preamble signal, and
the FFT start time point setting processor sets the point of time at which fast Fourier transform (FFT) is started to any one of a first value obtained by adding the length of the CP to the point of time at which the second preamble signal is received and a second value obtained by adding the length of the CP to an average value of the points of time at which the second and the third preamble signals are received.

20. The first node of claim 19, further comprising:
a second selection processor for selecting any one of the second to the fourth nodes when the point of time at which FFT is started does not satisfy an equation below; and
an FFT start time point update processor for updating the point of time at which FFT is started using a point of time at which any one of preamble signals received from nodes not selected by the second selection processor, from among the second to the fourth nodes, is received.
T₁−G_{R}≦R_{1, FFT}≦T₁+CP+G_{L} [Equation]
(R_{1, FFT}: the point of time at which the first node starts FFT, T₁: a point of time at which the first node transmits a signal, G_{L}: a length of a first guard interval included in a switching gap between frames transmitted and received by the first node and configured to delay a point of time at which a signal is transmitted and received, and G_{R}: a length of a second guard interval included in the switching gap and configured to advance a point of time at which a signal is transmitted and received).
